(19) United States
(12) Patent Application Publication
(10) Pub. No.: US 2026/0097622 A1
(43) Pub. Date: Apr. 9, 2026

(54) HEATING, VENTILATION, AND AIR CONDITIONING SYSTEM

(71) Applicant: VALEO SYSTEMES THERMIQUES, La Verriere (FR)

(72) Inventors: Cody BARNEBEE, Auburn Hills, MI (US); Steven MARSHALL, Auburn Hills, MI (US)

(73) Assignee: VALEO SYSTEMES THERMIQUES, La Verriere (FR)

(21) Appl. No.: 18/906,349

(22) Filed: Oct. 4, 2024

(51) Int. Cl. B60H 1/00

(52) U.S. Cl. CPC B60H 1/00021; B60H 1/00671; B60H 2001/00721

(57) ABSTRACT

The invention relates to a HVAC system including a housing and a blend door being pivotable along a pivot axis between a full hot position defining a 100% blend position and a full cold position defining a 0% blend position. The blend door includes a front side parallel to the pivot axis and two lateral sides and the housing includes a shade area configured to wrap around the front side, the lateral sides and the corner linking the front side to the lateral sides of the blend door, so as to restrict at least one air gap between the housing and the front side, at least one air gap between the housing and the lateral sides, and at least one air gap between the housing and the corner, when the blend door is in a predetermined angular range defined between the full hot position and the full cold position.

### TECHNICAL FIELD

The present invention relates to Heating, Ventilation, and Air Conditioning (HVAC) System.

### BACKGROUND OF THE INVENTION

A Heating, Ventilation, and Air Conditioning (HVAC) system is used for climate control of, e.g., cabin areas of a vehicle. The HVAC system comprise an air heat transfer device such as a heater core, disposed in a housing and one or more airflow paths for allowing air to flow, for example, to, from, and/or within said HVAC system. Blend doors, may be associated with the airflow path for controlling the amount of air flowing to, through, and/or from the HVAC system.

In particular, the temperature performance of the air heat transfer device needs to be improved, when the blend door is at 60% to 100% of blend positions, where a full hot position defines a 100% blend position and a full cold position defines a 0% blend position.

Therefore, there is a need to regulate effectively airflow to the heat transfer device to obtain and to maintain desired temperatures and comfort levels of the passengers within the cabin areas of the vehicle.

### SUMMARY OF THE INVENTION

In accordance with the purposes and benefits described herein, a heating, ventilation, and air conditioning system, in particular for a vehicle, said system comprising:
a housing;
an air heat transfer device, arranged in the housing and configured to exchange heat with an incoming airflow;
at least one airflow path, arranged in the housing and configured to lead the incoming flow to the air heat transfer device;
at least one blend door placed in said at least one airflow path, said at least one blend door being arranged to control distribution of the incoming airflow to the air heat transfer device along the at least one airflow path, said at least one blend door being pivotable along a pivot axis between a full hot position defining a 100% blend position and a full cold position defining a 0% blend position; and
   the at least one blend door including at least one front side parallel to the pivot axis and at least two lateral sides; and
   wherein the housing includes a shade area configured to wrap around:
the at least one front side of the at least one blend door;
at least one of the two lateral sides of the at least one blend door;
at least one corner linking the at least one front side to the at least one of the two lateral sides;
so as to restrict:
   at least one first air gap between the housing and the at least one front side;
   at least one second air gap between the housing and the at least one of the two lateral sides; and
   at least one third air gap between the housing and the at least one corner;
      when the at least one blend door is in a predetermined angular range defined between the full hot position and the full cold position.

The vehicle can be of a terrestrial, maritime, or aerial type. The vehicle can be, for example, an automobile.

In one embodiment, the system comprises:—a plurality of airflow paths, arranged in the housing and configured to lead the incoming flows to the air heat transfer device.

According to an aspect of the invention, the shade area is configured to wrap around only the predetermined angular range of the blend door. Thus, outside the predetermined angular range of the blend door is not shaded by said shade area.

According to an aspect of the invention, the predetermined angular range is defined between 60% and 100% of blend position, preferably between 70% and 100% of blend position of the blend door. Preferably, the predetermined angular range is comprised between 10° and 20°, more preferably between 13.5° and 18° with respect to the angle of the full hot position of the blend door.

According to an aspect of the invention, the second gap and the third gap have the same value.

Alternatively, the second gap and the third gap have different values.

Thanks to the shade area, the gaps between the blend door and the housing can be precisely adjusted. This provides a restriction to the incoming airflow as the blend door is in the predetermined angular range. Put differently, the shade area reduces a cross-sectional area between the housing and the blend door available for the incoming airflow as the blend door is in the predetermined angular range, thereby reducing, in a controlled manner, the ratio of an undesired incoming airflow mixed with the incoming airflow.

That is, the shade area significantly improves the linearity of the temperature gradient in an outgoing airflow, ensuring that the temperature changes felt by a passenger are more gradual and controlled as the blend door maintains its angular position in said predetermined angular range. This way, a sudden rise in temperature felt by a passenger receiving outgoing airflow is avoided.

In a nutshell, by modifying the shade area in the housing, the invention allows to improve the control and the efficiency of the incoming airflow through the system. This has also an advantage of being cost-effective, easily manufacturable, and integrable into an existing system design with a minimum modification the design, i.e., only at the level of the housing.

“Shade area” refers to a local area of the housing configured to meter or control the gaps between the housing and the blend door.

“Wrapping around” refers to the fact that the shade area has a general shape conforming to the shape of the front side, of at least one of the lateral sides, and of the at least one corner. In other words, the gaps between the housing and the blend door are substantially constant.

According to an aspect of the invention, the blend door is configured to guide the at least one incoming airflow, in particular the at least one cold incoming airflow, to the air heat transfer device and to guide the other at least incoming airflow, for example the other at least one cold incoming airflow, to a distribution zone of the airflow path, such that a hot airflow from the heat transfer device and said other incoming airflow could be blended in said distribution zone to form a mixed airflow as an outgoing airflow passing through said distribution zone.

This way, the blend door allows to achieve a desired temperature of the outgoing airflow, in particular to cabin areas of the vehicle.

According to an aspect of the invention, the gap is at least 1 mm. Advantageously, the gap is comprised between 1 and 4 mm.

According to an aspect of the invention, the gap is at least 1 mm when the blend door is at the full hot position or at the full cold position. Advantageously, the gap is comprised between 1 and 4 mm.

According to an aspect of the invention, the shade area includes at least one curved zone arranged to conform to a shape of the at least one corner of the blend door. Advantageously, the curved zone comprises a convex or a concave curve. Such curved zone allows to adjust the gap between the corner and the housing, thus allowing for a controlled airflow reduction.

The curved zone of the shade area is configured to floor the curvature of the blend door. The dimensions of the shade area are arranged to cover the predetermined angular range. The curvature and/or the dimensions of the curved zone are dependent on the shape and/or the size of the blend door.

According to an aspect of the invention, the shade area is configured such that the gaps between the at least one blend door and the housing decrease as the at least one blend door pivots towards the full hot position. In other words, the gaps are smaller as the blend door approaches the full hot position than when the blend door moves away from the full hot position.

According to an aspect of the invention, the blend door includes at least one air flap, the at least one front side, the at least one of the two lateral sides and the at least one corner being part of the at least one air flap.

Alternatively, the blend door comprises at least two air flaps each comprising said front side, lateral sides and corners. Said air flaps are located symmetrically on either side along the pivot axis of said blend door.

According to an aspect of the invention, the air heat transfer device is configured to receive a heated coolant and to exchange heat with an incoming airflow, in particular with a cold incoming airflow. Advantageously, the system further comprises an evaporator configured to cool the cold incoming airflow.

In one embodiment, the housing comprises an air inlet configured to receive an ambient air flow and an air outlet configured to discharge an outgoing airflow from the housing.

Alternatively, the air heat transfer device can be an inner condenser configured to be supplied with a refrigerant. Said inner condenser dispenses the use of said coolant. In this case, the inner condenser is used in heat-pump mode for heating the incoming air into the heating, ventilation, and air conditioning system.

According to an aspect of the invention, the shade area includes at least one rib wrapping around at least partially:
the at least one front side of the at least one blend door;
the at least one of the two lateral sides of the at least one blend door;
the at least one corner linking the at least one front side to at least one of the two lateral sides; so as to restrict at least partially:
   the at least one first air gap between the housing and the at least one front side;
   the at least one second air gap between the housing and the at least one of the two lateral sides; and
   the at least one third air gap between the housing and the at least one corner; when the at least one blend door is in the predetermined angular range defined between the full hot position and the full cold position.

According to an aspect of the invention, the shade area includes a plurality of the ribs, for example at least three ribs.

According to an aspect of the invention, at least one of the ribs comprises:
at least one straight portion configured to face the at least one of the two lateral sides of the at least one blend door.

According to an aspect of the invention, at least one of the ribs comprises:
at least one straight portion configured to face the at least one frontal side of the at least one blend door.

According to an aspect of the invention, at least one of the ribs comprises:
a curved portion configured to face the at least one corner of the at least one blend door.

Alternatively, the shade area comprises at least one rib wrapping only around the at least one corner linking the front side to at least one of the lateral sides so as to restrict at least one air gap between the housing and the corner.

Alternatively, the shade area comprises at least one rib wrapping only around at least one of the lateral sides of the blend door so as to restrict at least one air gap between the housing and at least one of the lateral sides.

Alternatively, the shade area comprises at least one rib wrapping only around the front side of the blend door so as to restrict at least one air gap between the housing and the front side.

Alternatively, at least one of the ribs is only provided on a part of the shade area configured to at least partially face:
at least one of the lateral sides;
the front side; and/or
the corner linking said lateral side to the front side.

Thus, the opposite part of said part of the shade area opposite side may have a continuous surface without any gap, for restricting at least one of the gaps between the housing and the blend door.

According to an aspect of the invention, at least two ribs of the plurality of the ribs are identical to each other.

Alternatively, at least two of the ribs are different from each other.

According to an aspect of the invention, at least two of the ribs are regularly spaced with a pitch d relatively to one another. Preferably, the pitch d is comprised between 2 and 4 mm.

According to an aspect of the invention, at least two of the ribs are regularly spaced in the direction of rotation along the pivot axis.

Alternatively, at least two of the ribs are irregularly spaced relatively to one another.

According to an aspect of the invention, at least two of the ribs are parallel to each other.

According to an aspect of the invention, at least one of the ribs extend in a plane that is parallel to the pivot axis.

According to an aspect of the invention, at least one of the ribs extends in a plane that contains the pivot axis.

According to an aspect of the invention, the housing includes:
at least two housing parts, for example a left and a right housing parts; and/or
a middle divider configured to be assembled with said at least two housing parts, with each on both sides of the middle divider, such that the middle divider is in fluidic contact with air of the at least one air flow path formed by said at least two housings parts.

According to an aspect of the invention, each housing part includes the blend door.

The housing may include only the housing parts, for example a left and a right housing parts. Put another way, the system may comprise said housing parts provided that there is no middle divider.

According to an aspect of the invention, the middle divider includes at least one of the ribs.

According to an aspect of the invention, the shade area includes at least one rib wrapping around at least partially:
the at least one front side of the at least one blend door;
the at least one of the two lateral sides of the at least one blend door;
the at least one corner linking the at least one front side to at least one of the two lateral sides; so as to restrict at least partially:
   the at least one first air gap between the housing and the at least one front side;
   the at least one second air gap between the housing and the at least one of the two lateral sides; and
   the at least one third air gap between the housing and the at least one corner;
      when the at least one blend door is in the predetermined angular range defined between the full hot position and the full cold position, wherein the middle divider includes the at least one rib.

According to an aspect of the invention, the middle divider includes a plurality of divider walls. The plurality of divider walls is configured to face one of the at least two housing parts. Preferably, at least one of the divider walls includes at least one of the ribs.

According to an aspect of the invention, at least two of the divider walls include each a set of ribs, such that the sets of ribs are symmetrical to each other with respect to the middle divider.

This improves the compactness as well as the manufacturability of the housing.

According to an aspect of the invention, the plurality of divider walls includes each at least a set of ribs, such that the sets of ribs are symmetrical to each other with respect to the middle divider.

According to an aspect of the invention, the angular aperture in which the ribs extend is comprised between 0° and 45°, preferably between 5 and 25°, more preferably between 10 and 15°, with respect to the angle of the full hot position of the blend door. 0° corresponds to when the ribs are parallel from each other.

According to an aspect of the invention, at least one of the two lateral sides of the blend door includes at least one of the ribs.

According to an aspect of the invention, the housing is a single piece. Preferably, the housing is made from a moldable plastic material.

Thus, this allows for cost-effective and efficient manufacturing of the housing.

According to an aspect of the invention, the middle divider is a single piece. Preferably, the middle divider is a molded part, in particular a plastic molded part.

The invention also relates to a heating, ventilation, and air conditioning system, in particular for a vehicle, said system comprising:
a housing;
an air heat transfer device, arranged in the housing and configured to exchange heat with an incoming airflow;
at least one airflow path, arranged in the housing and configured to lead the incoming airflow to the air heat transfer device;
at least one blend door placed in said at least one airflow path, said at least one blend door being arranged to control distribution of the incoming airflow to the air heat transfer device along the at least one airflow path, said at least one blend door being pivotable along a pivot axis between a full hot position defining a 100% blend position and a full cold position defining a 0% blend position; and
   the at least one blend door including at least one front side parallel to the pivot axis and two lateral sides; and
   wherein the housing includes a shade area including at least one rib wrapping around at least partially:
at least one corner linking the at least one front side to at least one of the two lateral sides;
so as to restrict:
   at least one air gap between the housing and the corner;
      when the blend door is in a predetermined angular range defined between the full hot position and the full cold position.

The shade area includes at least one rib wrapping further around at least partially:
the at least one front side of the at least one blend door;
at least one of the two lateral sides of the at least one blend door;
so as to restrict:
   at least one first air gap between the housing and the at least one front side;
   at least one second air gap between the housing and the at least one of the two lateral sides; and
      when the at least one blend door is in a predetermined angular range defined between the full hot position and the full cold position.

Thus, the presence of the at least one rib in the shade area, reduces drastically the incoming airflow passing through one of the gaps between the blend door and the housing.

Furthermore, the rib allows to obtain an optimal structural integrity of the housing and a desired airflow aerodynamics features around the ribs. In addition, the presence of the rib is compatible with a molding method, for example a molding method of a plastic material.

In one embodiment, the air heat transfer device could be a heater core configured to receive a coolant that is heated and to exchange heat with an incoming airflow, or a positive-temperature-coefficient (PTC) heating element configured to be electrically operated, thereby to be heated by the Joule effect.

Alternatively, the air heat transfer device could be an air gas cooler configured to receive a refrigerant that is cooled and to cool down the incoming air flow.

In the following description, there are shown and described, several embodiments of said system. As it should be realized, said systems are capable of other, different embodiments and their several details are capable of modification in various, obvious aspects all without departing from said systems set forth and described in the following claims. Accordingly, the drawings and descriptions should be regarded as illustrative in nature and not as restrictive.

### BRIEF DESCRIPTION OF DRAWINGS

Note that all of the features and configurations described above are purely examples. Other features, details and advantages of the invention will become clearer on reading the detailed description set out below, together with several embodiments provided purely as examples and by way of indication, with reference to the attached schematic drawings, in which:

FIG. 1 schematically shows, a sectional side view of the system comprising a blend door at a full hot position;

FIG. 2 schematically shows, a sectional side view of the system comprising a blend door at a full cold position;

FIG. 3 schematically shows, a sectional side view of the system comprising a blend door at a position comprised between the full hot position and the full cold position;

FIG. 4 is a top view of the system according to a variant of example;

FIG. 5 is a top view of the system according to another variant of example;

FIG. 6 is a perspective view of a blend door of the system of FIG. 5, with a particular focus on a corner of the blend door without any rib;

FIG. 7 is a perspective view of a blend door of the system of FIG. 5, with a particular focus on a corner of the blend door with ribs; and

FIG. 8 is a cross-sectional perspective view of the system of FIG. 4 comprising the blend door at different blend positions.

### DETAILED DESCRIPTION OF THE INVENTION

Throughout the description, identical elements or elements with the same function are designated by the same reference sign. For the sake of conciseness, only the differences between the described embodiments are detailed.

The following embodiments are examples. Although the description refers to one or more embodiments, this does not necessarily mean that each reference relates to the same embodiment, or that the features only apply to a single embodiment. Individual features of various embodiments can also be combined or interchanged in order to create other embodiments.

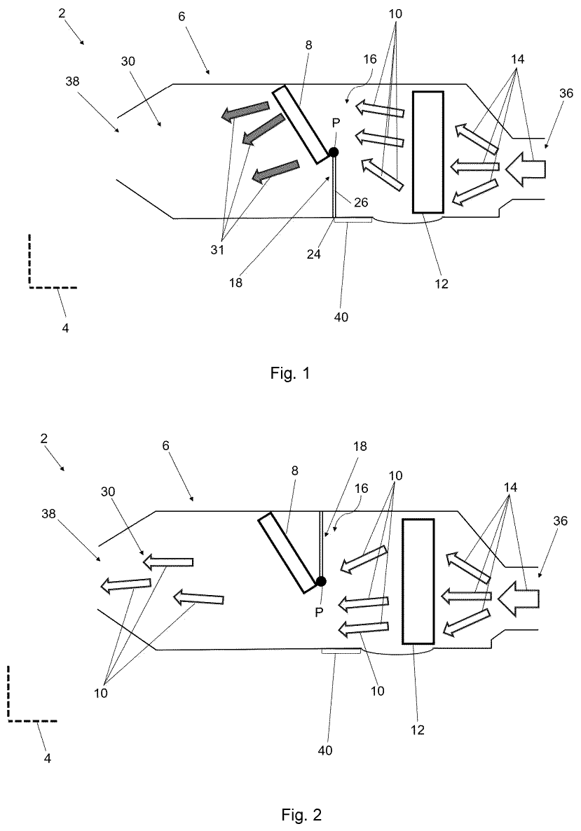

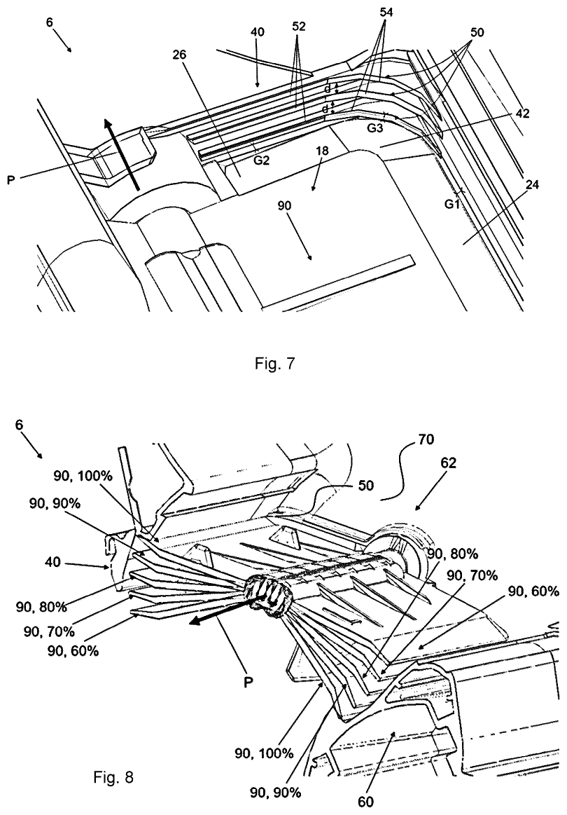

FIGS. 1, 2 and 3 show, schematically, a sectional side view of a heating, ventilation, and air conditioning system 2 for a vehicle 4 comprising:
a housing 6, in a single piece and made from a moldable plastic material;
a heater core 8, arranged in the housing 6 and configured to receive a coolant that is heated and to exchange heat with a cold incoming airflow 10;
an evaporator 12 configured to provide the cold incoming airflow 10 from an ambient airflow 14;
one or a plurality of airflow paths 16, arranged in the housing 6 and configured to lead the incoming flow to the heater core 8;
one blend door 18 placed in said airflow paths 16, said blend door 18 being arranged to control the distribution of the cold incoming airflow 10 to the heater core 8 along the airflow paths 16, and the blend door 18 being pivotable along a pivot axis P between a full hot position 20 defining a 100% blend position and a full cold position 22 defining a 0% blend position; and the blend door 18 comprising a front side 24 parallel to the pivot axis P and a plurality of lateral sides 26 (see also FIGS. 6 and 7).

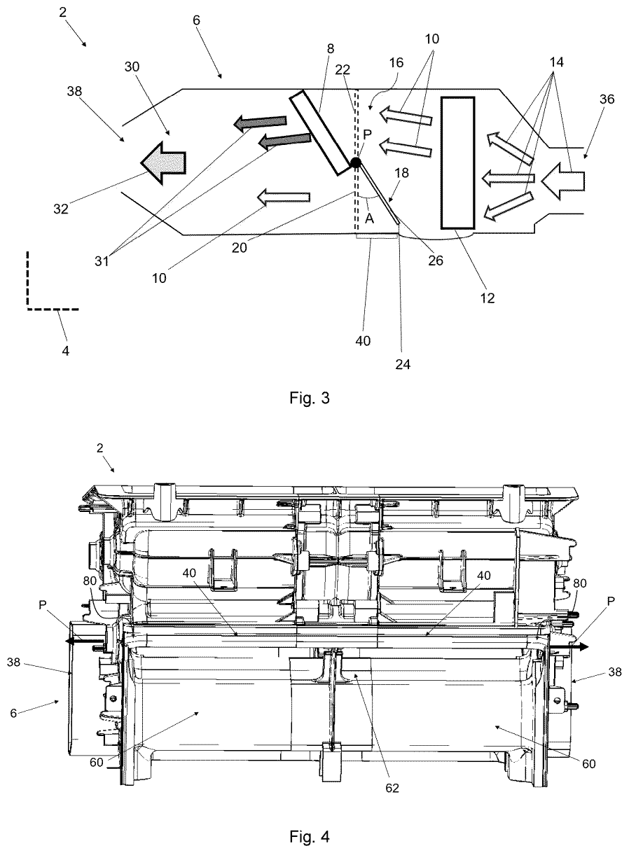

Referring in particular to FIG. 3, the blend door 18 is configured to guide the cold incoming airflow 10 to the heater core 8 and to guide the other cold incoming airflow 10 to a distribution zone 30 of the airflow paths 16, such that a hot airflow 31 from the heater core 8 and said other cold incoming airflow 10 could be blended in said distribution zone 30 to form a mixed airflow 32 as an outgoing airflow 32 passing through said distribution zone 30.

This way, the blend door 18 allows to achieve a desired temperature of the outgoing airflow 32, in particular to cabin areas (not-represented) of the vehicle 4.

The housing 6 comprises an air inlet 36 configured to receive the ambient air flow 14 and an air outlet 38 configured to discharge the outgoing airflow 32 from the housing 6.

As illustrated in FIGS. 1 to 3, and more particularly visible in the example shown in FIG. 6, the housing 6 comprises a shade area 40 configured to wrap around:
the front side 24 of the blend door 18;
the lateral sides 26 of the blend door 18;
the corners 42 linking the front side 24 to each lateral side 26;
so as to restrict:
   a first air gap G1 between the housing 6 and the front side 24;
   second air gaps G2 between the housing 6 and the two lateral sides 26; and
   third air gap G3 between the housing 6 and each corner 42;
      when the blend door 18 is in a predetermined angular range A defined between the full hot position 20 and the full cold position 22 (see FIG. 3).

The predetermined angular range A is defined between 60% and 100% of blend position, preferably between 70% and 100% of blend position of the blend door 18. Preferably, the predetermined angular range A is comprised between 10 ° and 20°, more preferably between 13.5° and 18° with respect to the angle of the full hot position 20 of the blend door 18.

As illustrated in FIGS. 1 to 3, and more particularly visible in the example shown in FIG. 7, the housing 6 includes a shade area 40 comprising a plurality of ribs 50 wrapping around:
the front side 24 of the blend door 18;
the lateral sides 26 of the blend door 18;
the corners 42 linking the front side 24 to each lateral side 26;
so as to restrict:
   the first air gap G1 between the housing 6 and the front side 24;
   the second air gaps G2 between the housing 6 and the two lateral sides 26; and
   the third air gaps G3 between the housing 6 and each corner 42;
      when the blend door 18 is in the predetermined angular range A defined between the full hot position 20 and the full cold position 22 (see FIG. 3).

The second gap G2 and the third gap G3 have different values.

Each rib 50 comprises:
one straight portion 52 configured to face one of the two lateral sides 26 of the blend door 18;
a curved portion 54 configured to face one of the corners 42 of the blend door 18.

As particularly shown in FIG. 7, the ribs 50 are identical to each other and are regularly spaced with a pitch d relatively to one another. Preferably, the pitch d is comprised between 2 and 4 mm.

The ribs 50 are regularly spaced in the direction of rotation along the pivot axis P and the ribs extend in a plane that is parallel to the pivot axis P.

The angular aperture in which the ribs 50 extend is comprised between 0° and 45°, preferably between 5 and 25°, more preferably between 10 and 15°, with respect to the angle of the full hot position of the blend door. 0° corresponds to when the ribs 50 are parallel from each other.

Referring to an example of FIG. 4, the housing 6 comprises:
a left and a right housing parts 60; and
a middle divider 62, a plastic molded part, and configured to be assembled with said housing parts 60, with each on both sides of the middle divider 62, such that the middle divider 62 is in fluidic contact with air of the airflow paths 16 formed by said housings parts 60.

Each housing part 60 includes the blend door 18.

Referring to FIG. 8, the middle divider 62 includes a plurality of divider walls 70, said divider walls 70 being configured to face the housing parts 60. Two of the divider walls 70 include each a set of ribs 50, such that the sets of ribs 50 are symmetrical to each other with respect to the middle divider 62.

This improves the compactness as well as the manufacturability of the housing 6.

The shade areas 40 includes each a curved zone 80 arranged to conform to the shape of the corners 42 of the blend door 18. Advantageously, the curved zone 80 comprises a convex or a concave curve. Such curved zone 80 allows to adjust the gap G3 between the corner 42 and the housing 6, thus allowing for a controlled airflow reduction.

The curved zone 80 of the shade area 40 is configured to floor the curvature of the blend door 18. The dimensions of the shade area 40 are arranged to cover the predetermined angular range A. The curvature and/or the dimensions of the curved zone 80 are dependent on the shape and/or the size of the blend door 18.

The shade area 40 is configured such that the gaps 50 between the blend door 18 and the housing 6 decrease as the blend door 18 pivots towards the full hot position 20. In other words, the gaps G1, G2, G3 are smaller as the blend door 18 approaches the full hot position 20 than when the blend door 18 moves away from the full hot position 20.

Referring in particular to FIG. 8, each blend door 18 includes two air flaps 90 each comprising said front side 24, lateral sides 26 and corners 42. Said air flaps 90 are located symmetrically on either side along the pivot axis P of said blend door 18.

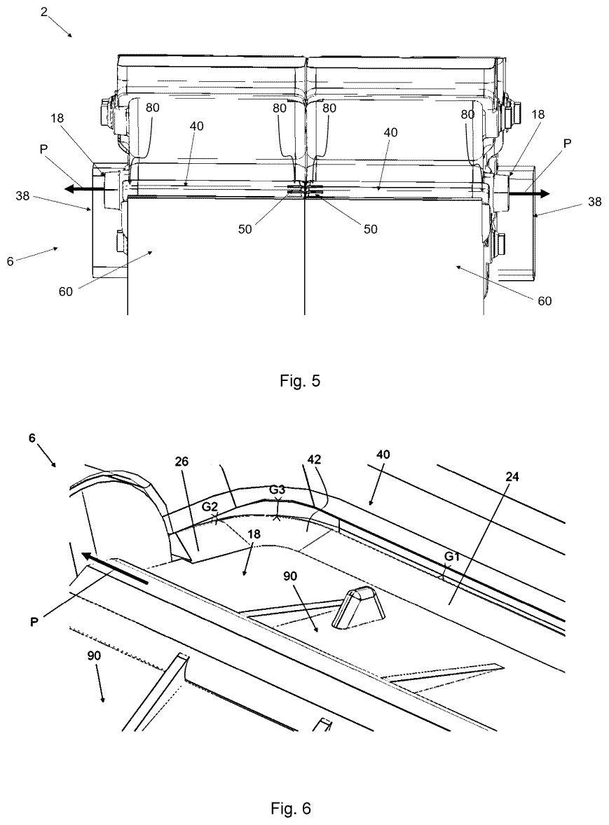

Referring now to an example illustrated in FIG. 5, the system 2 comprise only the housing parts 60, for example a left and a right housing parts 60. Put another way, the system 2 comprises said housing parts 60 provided that there is no middle divider.

In this example of FIG. 5, one of the curved zones 80 include the ribs 50.

The description of the invention is merely exemplary in nature and, thus, variations that do not depart from the gist of the invention are intended to be within the scope of the invention. Such variations are not to be regarded as a departure from the spirit and scope of the invention.

1. A heating, ventilation, and air conditioning system for a vehicle, comprising:
a housing;
an air heat transfer device, arranged in the housing and configured to exchange heat with an incoming airflow;
at least one airflow path, arranged in the housing and configured to lead the incoming airflow to the air heat transfer device;
at least one blend door placed in said at least one airflow path, said at least one blend door being arranged to control distribution of the incoming airflow to the air heat transfer device along the at least one airflow path, said at least one blend door being pivotable along a pivot axis between a full hot position defining a 100% blend position and a full cold position defining a 0% blend position; and
the at least one blend door including at least one front side parallel to the pivot axis and at least two lateral sides; and
wherein the housing includes a shade area configured to wrap around:
the at least one front side of the at least one blend door;
at least one of the two lateral sides of the at least one blend door;
at least one corner linking the at least one front side to the at least one of the two lateral sides;
so as to restrict:
at least one first air gap between the housing and the at least one front side;
at least one second air gap between the housing and the at least one of the two lateral
sides; and
at least one third air gap between the housing and the at least one corner;
when the at least one blend door is in a predetermined angular range defined between the full hot position and the full cold position.

2. The heating, ventilation, and air conditioning system according to claim 1, wherein the predetermined angular range is defined between 60% and 100% of blend position.

3. The heating, ventilation, and air conditioning system according to claim 1, wherein the at least one second gap and the at least one third gap have the same value.

4. The heating, ventilation, and air conditioning system according to claim 1, wherein the at least one second gap and the at least one third gap have different values.

5. The heating, ventilation, and air conditioning system according to claim 1, wherein the shade area includes a curved zone arranged to conform to a shape of the at least one corner of the blend door.

6. The heating, ventilation, and air conditioning system according to claim 1, wherein the shade area is configured such that the gaps between the at least one blend door and the housing decrease as the at least one blend door pivots towards the full hot position.

7. The heating, ventilation, and air conditioning system according to claim 1, wherein the at least one blend door includes at least one air flap, the at least one front side, the at least one of the two lateral sides and the at least one corner being part of the at least one air flap.

8. The heating, ventilation, and air conditioning system according to claim 1, wherein the air heat transfer device is configured to receive a heated coolant and to exchange heat with an incoming airflow.

9. The heating, ventilation, and air conditioning system according to claim 1, further comprising an evaporator configured to cool the incoming airflow.

10. The heating, ventilation, and air conditioning system according to claim 1, wherein the air heat transfer device is an inner condenser configured to be supplied with a refrigerant.

11. The heating, ventilation, and air conditioning system according to claim 1, wherein the shade area includes at least one rib wrapping around at least partially:
the at least one front side of the at least one blend door;
the at least one of the two lateral sides of the at least one blend door;
the at least one corner linking the at least one front side to at least one of the two lateral sides;
so as to restrict at least partially:
the at least one first air gap between the housing and the at least one front side;
the at least one second air gap between the housing and the at least one of the two lateral sides; and
the at least one third air gap between the housing and the at least one corner;
when the at least one blend door is in the predetermined angular range defined between the full hot position and the full cold position.

12. The heating, ventilation, and air conditioning system according to claim 11, wherein the shade area includes a plurality of the ribs.

13. The heating, ventilation, and air conditioning system according to claim 11, wherein the at least one of the ribs includes:
at least one straight portion configured to face the at least one of the two lateral sides of the at least one blend door;
at least one straight portion configured to face the at least one front side of the at least one blend door; and
a curved portion configured to face the at least one corner of the at least one blend door.

14. The heating, ventilation, and air conditioning system according to claim 12, wherein at least two ribs of the plurality of the ribs are identical to each other.

15. The heating, ventilation, and air conditioning system according to claim 1, wherein the housing includes:
at least two housing parts; and
a middle divider configured to be assembled with said at least two housing parts, with each on both sides of the middle divider, such that the middle divider is in fluidic contact with air of the at least one airflow path formed by said at least two housings parts.

16. The heating, ventilation, and air conditioning system according to claim 15, wherein the shade area includes at least one rib wrapping around at least partially:
the at least one front side of the at least one blend door;
the at least one of the two lateral sides of the at least one blend door;
the at least one corner linking the at least one front side to at least one of the two lateral sides;
so as to restrict at least partially:
the at least one first air gap between the housing and the at least one front side;
the at least one second air gap between the housing and the at least one of the two lateral sides; and
the at least one third air gap between the housing and the at least one corner;
when the at least one blend door is in the predetermined angular range defined between the full hot position and the full cold position, wherein the middle divider includes the at least one rib.

17. The heating, ventilation, and air conditioning system according to claim 16, wherein the middle divider includes a plurality of divider walls, the plurality of divider walls being configured to face one of the at least two housing parts, and at least two of the divider walls include each a set of ribs, such that the sets of ribs are symmetrical to each other with respect to the middle divider.

18. The heating, ventilation, and air conditioning system according to claim 12, wherein the at least one of the two lateral sides of the blend door includes at least one of the ribs.

19. A heating, ventilation, and air conditioning system for a vehicle, comprising:
a housing;
an air heat transfer device, arranged in the housing and configured to exchange heat with an incoming airflow;
at least one airflow path, arranged in the housing and configured to lead the incoming airflow to the air heat transfer device;
at least one blend door placed in said at least one airflow path, said at least one blend door being arranged to control distribution of the incoming airflow to the air heat transfer device along the at least one airflow path, said at least one blend door being pivotable along a pivot axis between a full hot position defining a 100% blend position and a full cold position defining a 0% blend position; and
the at least one blend door including at least one front side parallel to the pivot axis and at least two lateral sides; and
wherein the housing includes a shade area including at least one rib wrapping around at least partially:
at least one corner linking the at least one front side to at least one of the two lateral sides;
so as to restrict:
at least one air gap between the housing and the corner;
when the blend door is in a predetermined angular range defined between the full hot position and the full cold position.

20. The heating, ventilation, and air conditioning system according to claim 19, wherein the shade area includes at least one rib wrapping further around at least partially:
the at least one front side of the at least one blend door;
at least one of the two lateral sides of the at least one blend door;
so as to restrict:
at least one first air gap between the housing and the at least one front side;
at least one second air gap between the housing and the at least one of the two lateral sides; and
when the at least one blend door is in a predetermined angular range defined between the full hot position and the full cold position.
